(19) United States
(12) Patent Application Publication
(10) Pub. No.: US 2024/0338917 A1
(43) Pub. Date: Oct. 10, 2024

(54) SYSTEMS AND METHODS FOR IMAGE TO 3D GENERATION

(71) Applicant: Datum Point Labs Inc., Jackson, WY (US)

(72) Inventors: Yuanming Li, Seoul (KR); Bonhwa Ku, Seoul (KR); Hanseok Ko, Seoul (KR)

(21) Appl. No.: 18/625,844

(22) Filed: Apr. 3, 2024

Related U.S. Application Data
(60) Provisional application No. 63/457,579, filed on Apr. 6, 2023.

(51) Int. Cl. G06T 19/20; G06T 15/04; G06T 17/20

(52) U.S. Cl. CPC G06T 19/20; G06T 15/04; G06T 17/20; G06T 2219/2024

(57) ABSTRACT

Embodiments described herein provide systems and methods for image to 3D generation. A system receives an input image, for example a portrait. The system generates, via an encoder, a first latent representation based on the input image. The system generates, based on the first latent representation, a plurality of latent representations associated with a plurality of view angles. The system generates, via a decoder, a plurality of images in the plurality of view angles based on the plurality of latent representations. Finally, the system generates a final UV map based on the plurality of images.

### CROSS REFERENCE(S)

The instant application is a nonprovisional of and claim priority under 35 U.S.C. 119 to U.S. provisional application No. 63/457,579, filed Apr. 6, 2023, which is hereby expressly incorporated by reference herein in its entirety.

### TECHNICAL FIELD

The embodiments relate generally to systems and methods for image to 3D generation, and more specifically for portrait to 3D UV map generation.

### BACKGROUND

Three-dimensional (3D) face reconstruction from a single portrait is studied in computer vision and graphics due to its numerous applications, such as face recognition, avatar creation, and voice-driven facial animation. Despite progress achieved with the aid of deep learning in recent years, the lack of real 3D face data remains a major limitation to the performance of 3D face reconstruction. Furthermore, 3D texture data are scarce for other styles, such as cartoons, sketches, and other specific styles, which severely restricts research on diverse 3D avatar generation using deep learning techniques. Therefore, there is a need for improved systems and methods for portrait to 3D generation.

### BRIEF DESCRIPTION OF THE DRAWINGS

FIG. 1 illustrates a framework for training a map and edit image processing model, according to some embodiments.

FIG. 2A illustrates a framework for map and edit model inference, according to some embodiments.

FIG. 2B illustrates a framework for attribute editing, according to some embodiments.

FIGS. 3A-3B illustrate a framework for UV map generation, according to some embodiments.

FIG. 4 illustrates exemplary generated UV maps and corresponding 3D Meshes, according to some embodiments.

FIG. 5 is a simplified diagram illustrating a computing device implementing the framework described herein, according to some embodiments.

FIG. 6 is a simplified diagram illustrating a neural network structure, according to some embodiments.

FIG. 7 is a simplified block diagram of a networked system suitable for implementing the framework described herein.

FIGS. 8A-8C are example logic flow diagrams, according to some embodiments.

FIGS. 9A-9B are exemplary devices with digital avatar interfaces, according to some embodiments.

FIGS. 10-18 provide charts and images illustrating exemplary performance of different embodiments described herein.

### DETAILED DESCRIPTION

Three-dimensional (3D) face reconstruction from a single portrait is studied in computer vision and graphics due to its numerous applications, such as face recognition, avatar creation, and voice-driven facial animation. Despite progress achieved with the aid of deep learning in recent years, the lack of real 3D face data remains a major limitation to the performance of 3D face reconstruction. Furthermore, 3D texture data are scarce for other styles, such as cartoons, sketches, and other specific styles, which severely restricts research on diverse 3D avatar generation using deep learning technique.

Embodiments herein relate generally to methods for image manipulation using an artificial intelligence (e.g., neural-network based machine learning) model and a training method for the model. Specifically, a 3D morphable model (3DMM)-guided 2D facial manipulation algorithm, termed “map and edit”, that enables efficient and explicit separation and control of facial attributes. The ‘map and edit’ model can be trained in an end-to-end and self-supervised manner without any labeled dataset. Embodiments further include methods for to converting a single-face portrait into a UV facial texture by using an artificial intelligence-based generative model, which may include the image manipulation method for generating multi-view images as a precursor to the final UV map. Embodiments further include using the UV texture to generate realistic details for a 3D mesh. Methods described herein can also convert real human faces into UV maps having different styles such as cartoons, sketches, and other specific styles. 3D face reconstruction (e.g., image to UV map or 3D mesh) performed according to embodiments herein from a single portrait may be used in face recognition, avatar creation, speech-driven facial animation, and more.

Embodiments herein combine a 3D morphable model (3DMM) face model with a pre-trained decoder to achieve an attribute-controlled and disentangled 2D face model. In some embodiments, the 3DMM model is a model as described in Blanz et al., A morphable model for the synthesis of 3D faces, Proceedings of the 26^{th} Annual Conference on Computer Graphics and Interactive Techniques, pp. 187-194, 1999. In some embodiments, the pre-trained decoder may be StyleGAN2 as described in Karras et al., Analyzing and improving the image quality of StyleGAN, CVPR, pp. 8110-8119, 2020.

Map and edit may be used for image manipulation, learning explicit control over facial pose, lighting, and expression in latent space via self-supervision. Map and edit may map directly between W+ space and 3DMM coefficient (morphable) space, and edit the images generated by a 2D image generator by editing the properties of the 3DMM coefficient corresponding to the latent code. Embodiments described herein allow the model to extrapolate beyond what is well represented in the training set, allowing precise control over the pose, facial expression, and lighting of the face. In addition, since face images can be generated at specified angles, this ability may be used for multi-view face image generation.

In one embodiment, an input image (e.g., portrait of a face) is received and processed to generate a multi-view portrait. For example, using the “map and edit” method, an input image may be edited into a number of view angles to generate a multi-view set latent representations which may be decoded into images. The generation of the images may be further controlled via style transfer, for example based on a reference style image. For example, methods described herein can convert real human faces into UV maps having different styles such as cartoons, sketches, and other specific styles by combining “map and edit” with a decoder model that provides style transfer capability.

In further embodiments, the resulting multi-view portrait is mapped into UV space to complete a realistic (or stylized) 3D facial texture for each view of the multi-view portrait. The UV facial texture is blended with a 3D mesh to generate a final UV texture. Specifically, in some embodiments, predicted 3D information of a generated set of multi-view images may be used to generate respective visibility masks and UV maps. By combining synthesized multi-view face images and the corresponding visibility mask, models described herein may also produce a high-quality combined UV map which would allow more detailed 3D mesh generation. Another by-product is that a paired dataset containing images of faces and corresponding multiple styles of UV maps may be provided for the training of an image-to-image translation model.

Embodiments described herein provide a number of benefits. The simple and efficient framework described herein for obtaining high-fidelity UV maps from a single photo in-the-wild, compared with the previous methods, has a huge advantage in the fidelity and generation speed of real-world images. Unlike other 3DMM-guided methods, models are trained without photometric loss and without a face parsing model to train the model. In this way, the methods described herein avoid the domain gap issue encountered by the previous methods. Models described herein may be trained without paired input/output image data via a self-supervised method. Images produced may be less blurry than those produced by other methods due to the map and edit functionality described herein. The proposed model is trained self-supervised without any manual annotations or datasets. Extensive evaluations demonstrate that our proposed method can generate diverse style textures with higher fidelity than previous methods. Further, models described herein after training may be utilized in inference without further fine-tuning for specific images or styles. This results in higher quality generated images, UV maps, and/or 3D meshes with less computation and/or lower memory requirements. In comparison. alternative methods for UV map generation require a heavy computational load and often fails to maintain the personal identity of the input image. Models described herein can also be plugged and used in StylGAN2-related models (e.g., GAN inversion, fine-tuning StyleGAN2, etc.). This facilitates editing of real images and style-transferred images.

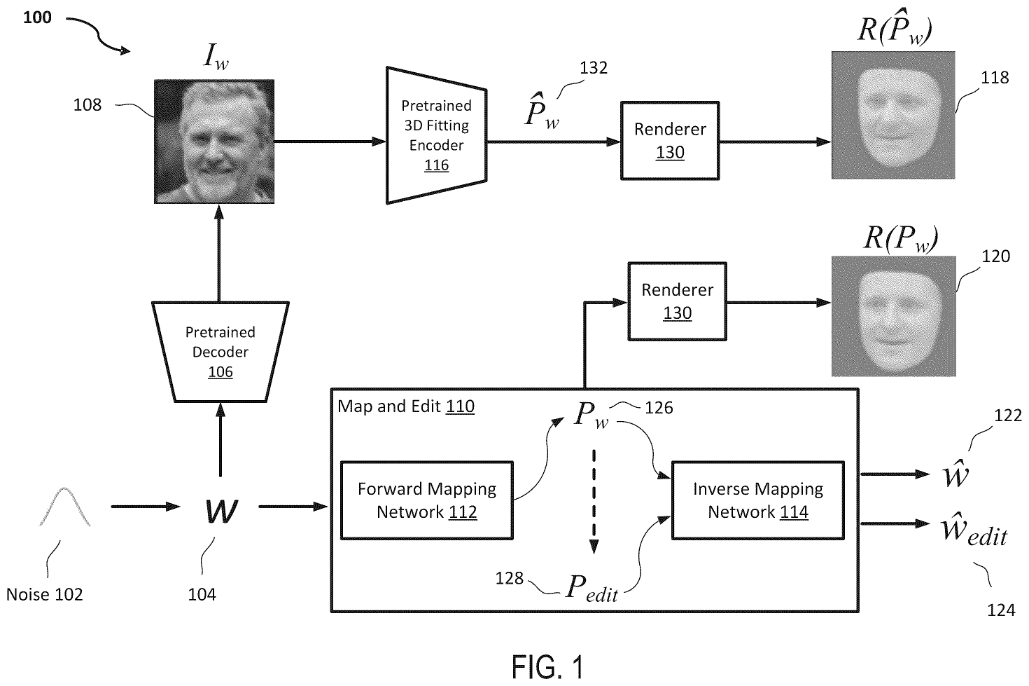

FIG. 1 illustrates a framework 100 for training a map and edit image processing model 110, according to some embodiments. Framework 100 includes a map and edit model 110, a pre-trained decoder 106 (e.g., StyleGAN2) and a pretrained 3D fitting encoder 115 (e.g., a 3DMM model). Pretrained decoder 106 may be seen as a function that maps latent codes 104 w∈ [symbol] ^{18×52} to realistic portrait images 108 of human faces I_{w}=G(w)∈ [symbol] ^{3×WχH}. In some embodiments, 3D fitting encoder 115 is a convolutional neural network (CNN) based model represented as the function E(⋅). For a given 2D face image 108 I, pretrained 3D fitting encoder 116 may estimate the 3D reconstruction of the face (i.e., latent representation 132), wherein the 3D shape may be computed as:

$$S = \overline{S} + {A}_{id} α + {B}_{exp} β \qquad ( 1 )$$

where S̅∈ [symbol] ^{×3} is the mean face shape and n is the number of the vertices. A_{id} and Bₑₓₚ are the principal component analysis (PCA) bases of the identity and expression. α and β are the identity and expression coefficients of 3DMM. Pretrained 3D fitting encoder 116 may estimate the geometry and color based on a set of 3DMM coefficients x=(α, β, δ, γ, ϕ, τ)∈ [symbol] ²⁵⁷, which depict the identity α∈ [symbol] ⁸⁰, texture β∈ [symbol] ⁸⁰, expression δ∈ [symbol] ⁶⁴, illumination γ∈ [symbol] ²⁷, face rotation ϕ∈SO(3), and translation t∈ [symbol] ³, which together may be represented as latent representation 132 \hat{P}_{w}.

Map and edit model 110 is trained to obtain the corresponding semantic direction in the latent space of latent code 104 (e.g., StyleGAN latent space or W+ latent space) by modifying the 3DMM semantic parameters and applying them to the original latent code 104. The map and edit model 110 allows for utilization of the relative strengths of each embedding space. Specifically, the semantic parameters of the 3DMM morphable space may be utilized while still maintaining the high quality texture details of the W+ space. In some embodiments, map and edit model 110 consists of two neural-network based models: a forward mapping network 112, referred to as M_{f} and inverse mapping network 114, referred to as Mᵢ. Forward mapping network 112 and/or inverse mapping network 114 may be implemented, for example, as multi-layer perceptrons (MLPs) that can map between the latent space (i.e., W+ space 216) and the 3DMM parameter space (i.e., morphable space 218), i.e. M_{f}: [symbol] ^{18×512}⇒ [symbol] ²⁵⁷, Mᵢ: [symbol] ²⁵⁷⇒ [symbol] ^{18×52}. Map and edit model 110 allows editing of the facial images based on semantic and interpretable control parameters, including images generated by StyleGAN2.

As shown in FIG. 1, latent code 104 w may be initialized with random noise 102. Latent code 104 may by used to generate the image Iw=G(w) through the pretrained decoder 106 (e.g., StyleGAN generator). Then, the 3DMM parameters (i.e., latent representation) 132 \hat{P}_{w}=E(I_{w}) of I_{w} are extracted using the pretrained 3D fitting encoder 116 model. The forward mapping network 112 M_{f} converts the latent 104 w into latent representation 126 P_{w}=M_{f} (w), and then generates the reconstructed latent code 122 ŵ=Mᵢ(P_{w}), through the inverse mapping network 114 Mᵢ. semantic control parameters of P_{w} (expression δ, face rotation ϕ and illumination γ) may be edited to get latent representation 128 P_{edit} after the semantic information has been changed. Inverse mapping network 114 Mᵢ may be used again to map latent representation 128 P_{edit} to the W+ space to get latent representation 124 ŵ_{edit}=Mᵢ(P_{edit}), where ŵ_{edit} is the semantic-transformed version of ŵ.

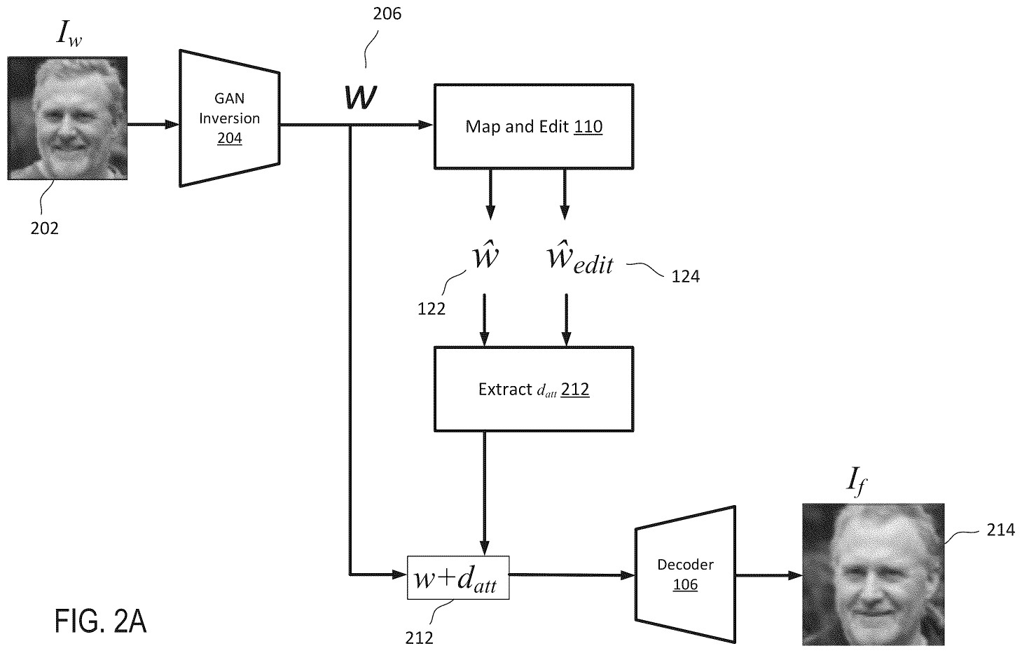

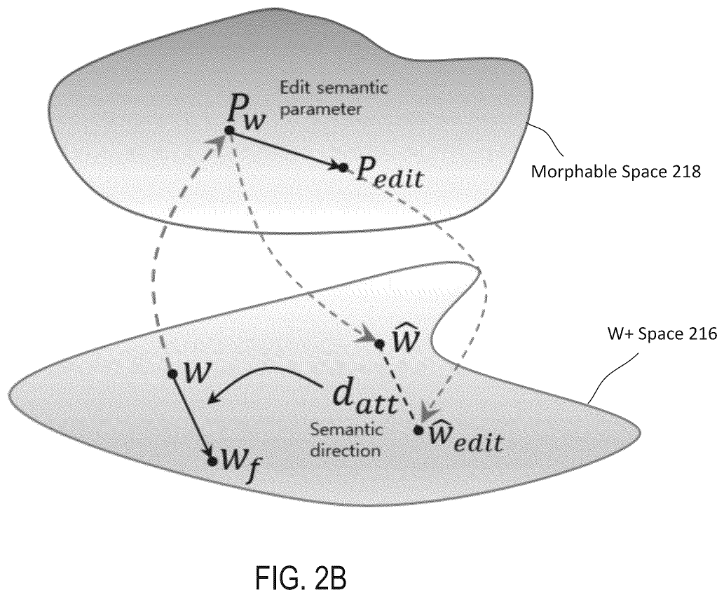

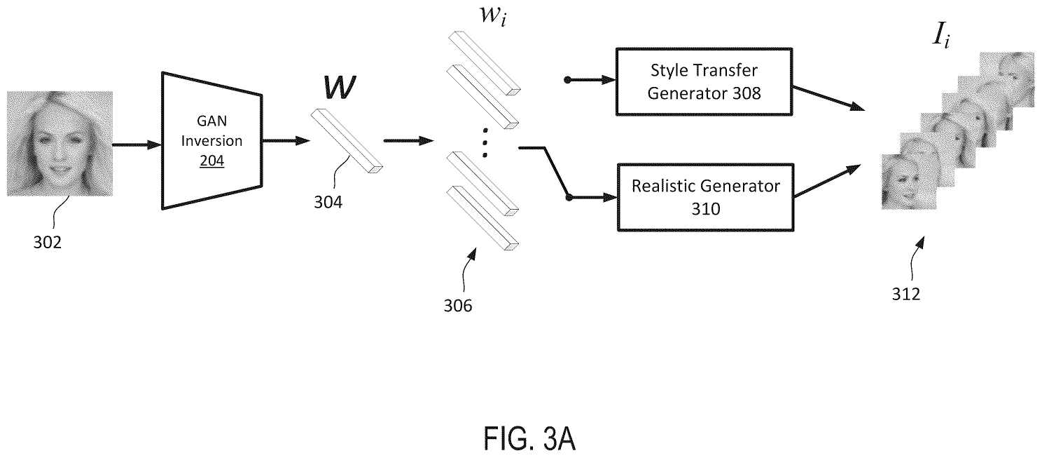

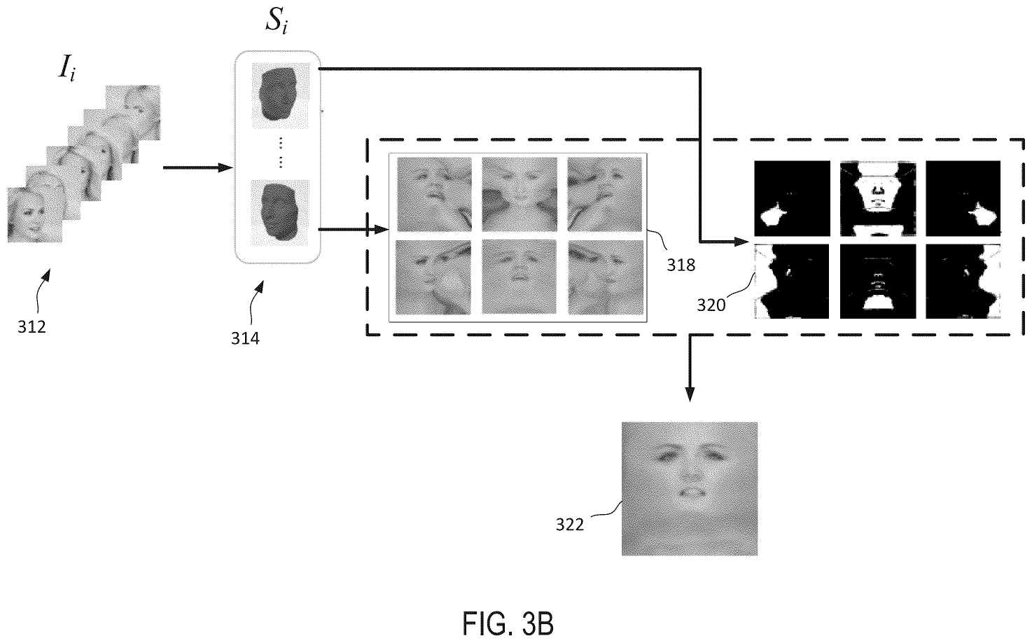

Map and edit model 110, more specifically forward mapping network 112 and inverse mapping network 114, may be trained via backpropagation to update parameters according to one or more loss functions. The loss functions described below may be used alone or in any combination, including weighted combinations. In some embodiments, forward mapping network 112 and inverse mapping network 114 are trained independently. In some embodiments, forward mapping network 112 and inverse mapping network 114 are trained jointly with a unified loss function. Note that loss functions described below do not require the existence of an existing training dataset, but rather may use random noise inputs, and train via a self-supervised method with the aid of pretrained decoder 106, pretrained 3D fitting encoder 116, and/or renderer 130. At inference, map and edit model 110 may be utilized with or without these other components, for example as described in FIGS. 2A-3B.

Training of map and edit 110 may be divided into two goals, one is the training of forward mapping network 112 M_{f} that can map the latent space to the 3DMM parameter space, and the other is the training of inverse mapping network 114 Mᵢ that maps backward. Five different loss functions are described herein: the rendered image loss, the 3DMM parameter loss, the latent reconstruction loss, landmark loss, and the regularization loss. A combined loss utilizing each of these five losses as a component may be represented as:

$${L}_{final} = {L}_{ren} + {λ}_{p} {L}_{p} + {λ}_{lat} {L}_{lat} + {λ}_{lm} {L}_{lm} + {L}_{reg} \qquad ( 2 )$$

where Lᵣₑₙ is the rendered image loss, Lₚ is the 3DMM parameter loss, Lₗₐₜ is the latent reconstruction loss, Lₗₘ is the landmark loss, L_{reg} is the regularization loss, and the A parameters are hyperparameters for controlling the relative weight of each loss function.

A rendered image loss may be used for training forward mapping network 112 M_{f} to directly map from W+ latent space to 3DMM space. The distance between rendered images 118 and 120 may be used to compute the rendered image loss as follows:

$${L}_{ren} = {‖ R ( {P}_{w} ) - R ( {\hat{P}}_{w} ) ‖}_{1} \qquad ( 3 )$$

where P_{w} and \hat{P}_{w} are 3DMM parameters (i.e., latent representations 126 and 132) obtained by the application of forward mapping network 112 M_{f}(w) and pretrained 3D fitting encoder 116 E(I_{w}), respectively. R(⋅) denotes the differentiable renderer 130.

Although it is possible to learn rough information about the pose, skin color, and lighting through Lᵣₑₙ, however, the details of texture and expression are not well-reacted. Therefore, a 3DMM parameter loss may be utilized by comparing latent representations 126 and 132, called lₚ, to increase the response to these details in 3DMM (morphable) space, represented as:

$${L}_{p} = {‖ {P}_{w} - {\hat{P}}_{w} ‖}_{1} \qquad ( 4 )$$

To ensure that map and edit model 110 is able to go from 3DMM space to latent space accurately, the latent reconstruction loss may be employed comparing latent representations 104 and 122 as follows:

$${L}_{lat} = {‖ w - \hat{w} ‖}_{1} \qquad ( 5 )$$

where ŵ=Mᵢ(M_{f}(w)) is the reconstructed version of w.

Landmarks may also be used as supervision for expression and pose. In some embodiments, landmarks are not extracted directly at the image level, but by utilizing landmark index from vertices of 3DMM. Landmark loss may be represented as:

$${L}_{lm} = 1 / N {\sum }^{N} {‖ {q}_{w} - {\hat{q}}_{w} ‖}_{1} + 1 / N {\sum }^{N} {‖ {q}_{edit} - {\hat{q}}_{edit} ‖}_{1} \qquad ( 6 )$$

where q_{w}, \hat{q}_{w}, q_{edit}, and \hat{q}_{edit} are landmarks extracted from latent representations 126, 132, and 128 (P_{w}, \hat{P}_{w} and P_{edit}) and a reconstructed latent representation \hat{P}_{edit} (not shown). N is the number of landmarks, (e.g., 68 points). Since there is no ground truth reference for latent representation 124 ŵ_{edit}, the second term in landmark loss may be included to ensure that the attribute of latent representation 124 ŵ_{edit} is consistent with the attribute of latent representation 128 P_{edit}. Specifically, the second term minimizes the difference between the predicted landmarks (edit) from the edited pose (\hat{P}_{edit}) and the landmarks extracted directly from the edited pose (q_{edit}). This approach provides an unsupervised learning signal for the system to improve the prediction of the third latent representation without the need for ground truth data for the edited landmarks (ŵ_{edit}). Latent representation 132 \hat{P}_{edit} is the reconstructed version of P_{edit}. \hat{P}_{edit} may be reconstructed by inputting latent representation 124 ŵ_{edit} to forward mapping network 112, represented as \hat{P}_{edit}=M_{f}(ŵ_{edit}).

To prevent face shape and texture degeneration, a regularization loss may be used to accelerate the convergence of the 3DMM parameter as follows:

$${L}_{reg} = {λ}_{α} {‖ α ‖}^{2} + {λ}_{β} {‖ β ‖}^{2} + {λ}_{δ} {‖ δ ‖}^{2} \qquad ( 7 )$$

where α, β and δ, are identity, expression and texture parameters of 3DMM.

FIG. 2A illustrates a framework for map and edit model inference, according to some embodiments. Specifically, the framework in FIG. 2A illustrates a method in which a map and edit model 110 (e.g., trained as described in FIG. 1) is used to modify an unseen image at inference. As described above with respect to FIG. 1, latent representations 122 and 124 (ŵ and ŵ_{edit}) may be generated using the ‘Map and edit’ network 110. In an ideal case, latent representation 124 ŵ_{edit} is the edited version of latent code input 206. However, one of the critical issues is that the dimension of the latent code 206 w∈ [symbol] ^{18×512} is much larger than the dimension of the 3DMM parameter p∈ [symbol] ²⁵⁷. Therefore, it will lead to the loss of some information of w, that is, the w and w (latent representations 206 and 122) will produce a certain degree of the gap in identity characteristics. Thus, the framework cannot use the w_{edit} to directly generate the final version image.

To address the problem of information loss caused by dimensional differences, a pretrained GAN inversion model 204 is employed to embed an input image 202 I_{w} into latent representation 206 w. In some embodiments, the pretrained GAN inversion model is a model as described in Tov et al., Designing an encoder for StyleGAN image manipulation, arXiv: 2102.02766, 2021. Through map and edit 110, paired latent codes 122 and 124 (ŵ, ŵ_{edit}) are generated representing a reconstruction of the input latent representation 206, and an edited latent representation that is modified via morphable (3DMM) parameters. The corresponding semantic direction dₐₜₜ may be extracted at block 212. For example, dₐₜₜ may be extracted by subtracting the vector of latent representation 122 from the vector of latent representation 124. Finally, this semantic direction dₐₜₜ may be utilized to edit the w and produce the final image 214. For example, dₐₜₜ may be added to latent representation 206 w, and the result may be used to generate an image via decoder 106. This may be represented as I_{f}=G(w+dₐₜₜ). In some embodiments, decoder 106 is a pretrained StyleGAN2 generator. This process of semantic direction extraction is described further in reference to FIG. 2B.

FIG. 2B illustrates a framework for attribute editing, according to some embodiments. Specifically, FIG. 2B is a visual representation of the method described in FIG. 2A for modifying an image representation. While W+ space 216 and Morphable (3DMM) space 218 are high-dimensional spaces, they are represented here in a simplified 2D manner. FIG. 2B is illustrative of how the edits made in morphable space 218 may be applied to W+ space 216, thereby taking advantage of the semantic parameterization of morphable space 218, while maintaining the fidelity of W+ space 216. First, P_{w} is obtained by encoding w (e.g., via forward mapping network 112) P_{w}=M_{f}(w). One or more semantic parameters of P_{w} are edited to obtain P_{edit}. For example, an identity attribute may be the same for both P_{w} and P_{edit}, but a view angle may be modified. ŵ and ŵ_{edit} may be generated based on P_{w} and P_{edit} (e.g., via inverse mapping network 114). At this time, w and ŵ_{edit} may have the same identity attribute but a different semantic direction, or some other parameter(s) may be adjusted. Semantic direction dₐₜₜ may be extracted with the following equation: dₐₜₜ=ŵ−ŵ_{edit}. Finally, this semantic direction dₐₜₜ may be utilized to edit the original w and produce the final image I_{f}=G(w+dₐₜₜ) as described in FIG. 2A.

FIGS. 3A-3B illustrate a framework for UV map generation, according to some embodiments. In some embodiments, the UV map generation framework utilizes the map and edit model 110 described in FIGS. 1-2B. The framework of FIGS. 3A-3B may be used to produce either a realistic 3D representation (UV map and/or mesh) or as described below may be used to produce a style-modified 3D representation. FIG. 3A illustrates generating a set of multi-view images based on a single input image, and FIG. 3B illustrates generating a UV map based on the set of multi-view images.

FIG. 3A illustrates a framework for generating a set of multi-view images 312 based on a single input image 302. Given a input image 302 I₀, a GAN inversion model 204 (or any other suitable encoder) F may generate latent representation 304 w=F(I). Then, utilizing map and edit 110, face image representations 306 wᵢ may be generated. For example, as described in FIGS. 2A-2B, latent representation 304 w may be input to map and edit model 110, which may output a reconstructed ŵ and an edited ŵ_{edit} which is based on an edited internal representation (e.g., edited to adjust viewing angle). This process may be repeated with different parameter changes so that each desired view angle is represented in image representations 306 wᵢ. Image representations 306 wᵢ may be used to generate the set of multi-view images 312 {Iᵢ}₀⁵={G(wᵢ)}₀⁵, using a generator. The generator may be a style transfer generator 308, or a realistic generator 310. The decision of which generator to use may be done at system implementation time, or may be selected dynamically at inference. If using style transfer generator 308, a reference style image (or a latent representation thereof) may be input to style transfer generator 308 as a conditioning input so that the style of the reference style image is transferred to the output images of style transfer generator 308. In some embodiments, realistic generator 310 is the same model as style transfer generator 308, only without the style image input. In some embodiments, the style transfer is achieved via the transfer of image statistics via one or more normalization layers, and in the case of not transferring a style, the normalization may occur without the transfer of statistics. In some embodiments, style transfer generator 308 applies a style based on a fine-tuning of the style transfer generator 308, rather than a reference image at inference. Style transfer generator 308 is described further below.

FIG. 3B illustrates generating a UV map 322 based on the set of multi-view images 312. Given a camera parameter (e.g., a set of view angles) {cᵢ}₀⁵, the framework computes estimated vertices 314 Sᵢ at specified views cᵢ. A visibility mask 320 M={mᵢ}₀⁵ ∈ [symbol] ^{1×1024×1024} may be computed based on the images 312 and/or vertices 314 and UV map 318 U={Iᵢ^{UV}}₀⁵ ∈ [symbol] ^{3×1024×1024} for each target angles. In some embodiments, the visibility mask 320 is defined as maintaining optimal visibility of each part of the face in a near-vertical view. The framework may compute a visibility score Vi which ranges between (−1, 1) for each 3D mesh (vertices 314 Sᵢ) according to the estimated vertices Sᵢ at specified view cᵢ:

$${V}_{i} = ( \frac{[ {S}_{i} ]}{{‖ [ {S}_{i} ] ‖}_{2}} \cdot {𝒩 ( {S}_{i} )}^{T} ) \qquad ( 8 )$$

where [symbol] (Sᵢ) is the normals of vertex 314 Sᵢ. Given the images 312 Iᵢ, the framework performs UV map 318 Iᵢ^{UV} and visibility mask 320 mᵢ with 3DMM vertices 314 Sᵢ ∈ [symbol] ^{n×3} and texture coordinate t_{co} ∈ [symbol] ^{n×2} as follows:

$${I}_{i}^{UV} = R ( {t}_{co ,} {I}_{i ,} {S}_{i} ) \qquad ( 9 )$$

$${m}_{i} = R ( {t}_{co ,} {V}_{i ,} {S}_{i} ) \qquad ( 10 )$$

where R is image-to-UV rendering. In some embodiments, the framework unfolds the input image into the UV space by swapping the vertex coordinates with the texture coordinates and the texture UV map with the input image (respective image of images 312). Regarding the intersecting regions among masks 320 mᵢ, the mask with the higher visibility score is selected.

The final UV map can be generated by stitching the visibility mask 320 mᵢ and UV map 318 Iᵢ^{UV} for each angle cᵢ as follows:

$${U}_{i} = {I}_{i - 1}^{UV} ⊙ ( 1 - {m}_{i} ) + {I}_{i}^{UV} ⊙ {m}_{i} \qquad ( 11 )$$

Once a UV map is generated, it may be applied to a 3D mesh to provide a controllable 3D representation of the input image 312. The 3D mesh may be used, for example, as a virtual avatar that may be manipulated in 3D space for display on a user interface device.

The framework in FIGS. 3A-3B may be used to produce a style-modified 3D representation (e.g., UV map 322) of an input image 302. As described above, style transfer UV map generation may be performed based on the realistic UV map generation framework. Instead of realistic generator 310, a style transfer generator 308 may be used. In some embodiments, style transfer may be realized by transferring the style of a second input reference image by style transfer generator 308. In some embodiments, style transfer generator 308 is a fine-tuning StyleGAN2 model that generates face images with a specified style. For example, each style may be achieved via a different fine-tuned version of the style transfer generator 308 instead of using a reference image at inference. When given a specified view, the process of generating style transfer images can be seen as a combination of image-to-image translation and face pose editing in latent space. The most changed part of the fine-tuning model is the feature convolution weights of the synthesis network. In contrast, changes in the mapping network and affine layers may be negligible. This means that the learned latent space W is hardly affected by fine-tuning of style transfer generator 308. Thus, the latent space semantics extracted in the original StyleGAN2 can be applied to the latent space of the fine-tuning model (style transfer generator 308).

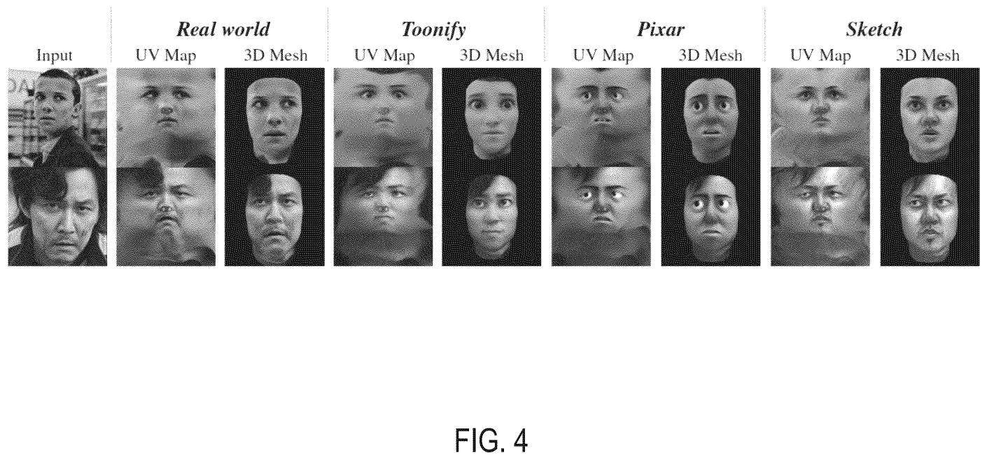

FIG. 4 illustrates exemplary generated UV maps and corresponding 3D Meshes, according to some embodiments. Two example input images are illustrated, with corresponding generated UV maps and 3D meshes based on those UV maps. The first examples represent realistic UV map generation. Subsequent examples illustrate the style transfer capabilities, specifically illustrating “Toonify,” “Pixar,” and “Skech” styles.

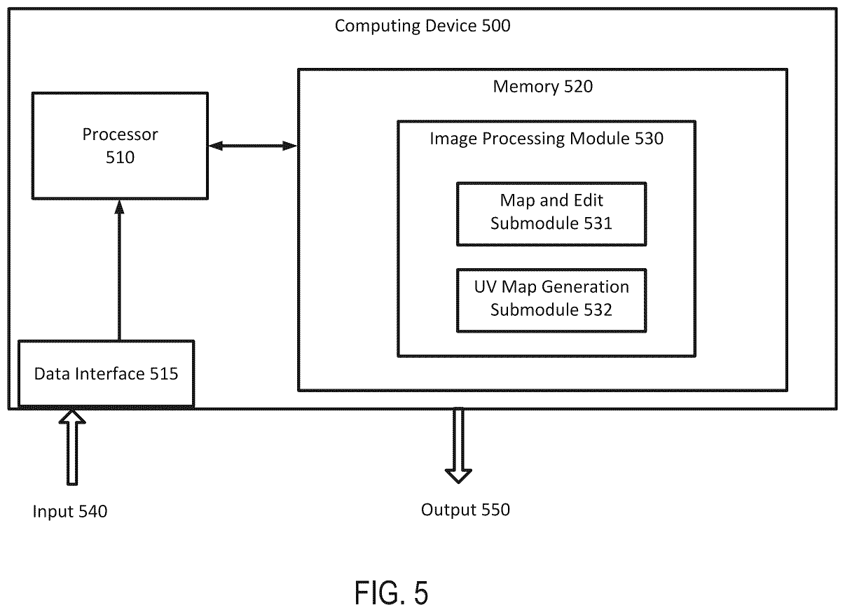

FIG. 5 is a simplified diagram illustrating a computing device 500 implementing the framework described herein, according to some embodiments. As shown in FIG. 5, computing device 500 includes a processor 510 coupled to memory 520. Operation of computing device 500 is controlled by processor 510. And although computing device 500 is shown with only one processor 510, it is understood that processor 510 may be representative of one or more central processing units, multi-core processors, microprocessors, microcontrollers, digital signal processors, field programmable gate arrays (FPGAs), application specific integrated circuits (ASICs), graphics processing units (GPUs) and/or the like in computing device 500. Computing device 500 may be implemented as a stand-alone subsystem, as a board added to a computing device, and/or as a virtual machine.

Memory 520 may be used to store software executed by computing device 500 and/or one or more data structures used during operation of computing device 500. Memory 520 may include one or more types of transitory or non-transitory machine-readable media (e.g., computer-readable media). Some common forms of machine-readable media may include floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

Processor 510 and/or memory 520 may be arranged in any suitable physical arrangement. In some embodiments, processor 510 and/or memory 520 may be implemented on a same board, in a same package (e.g., system-in-package), on a same chip (e.g., system-on-chip), and/or the like. In some embodiments, processor 510 and/or memory 520 may include distributed, virtualized, and/or containerized computing resources. Consistent with such embodiments, processor 510 and/or memory 520 may be located in one or more data centers and/or cloud computing facilities.

In some examples, memory 520 may include non-transitory, tangible, machine readable media that includes executable code that when run by one or more processors (e.g., processor 510) may cause the one or more processors to perform the methods described in further detail herein. For example, as shown, memory 520 includes instructions for image processing module 530 that may be used to implement and/or emulate the systems and models, and/or to implement any of the methods described further herein.

Image processing module 530 may receive input 540 such as input images, etc. and generate an output 550 such as a modified image, a UV map or a 3D mesh. For example, image processing module 530 may be configured to train and/or perform inference of a map and edit model, including performing image manipulation, and performing UV map generation. Image processing module 530 may include a map and edit submodule 531 that performs the training and/or inference of map and edit model 110. Image processing module 530 may include UV map generation submodule 532 that may generate UV maps and/or 3D meshes. UV map generation submodule 532 may utilize a map and edit model 110 (e.g., as encapsulated in map and edit submodule 531).

The data interface 515 may comprise a communication interface, a user interface (such as a voice input interface, a graphical user interface, and/or the like). For example, the computing device 500 may receive the input 540 from a networked device via a communication interface. Or the computing device 500 may receive the input 540, such as an input image (e.g., a portrait), from a user via the user interface.

Some examples of computing devices, such as computing device 500 may include non-transitory, tangible, machine readable media that include executable code that when run by one or more processors (e.g., processor 510) may cause the one or more processors to perform the processes of method. Some common forms of machine-readable media that may include the processes of method are, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, and/or any other medium from which a processor or computer is adapted to read.

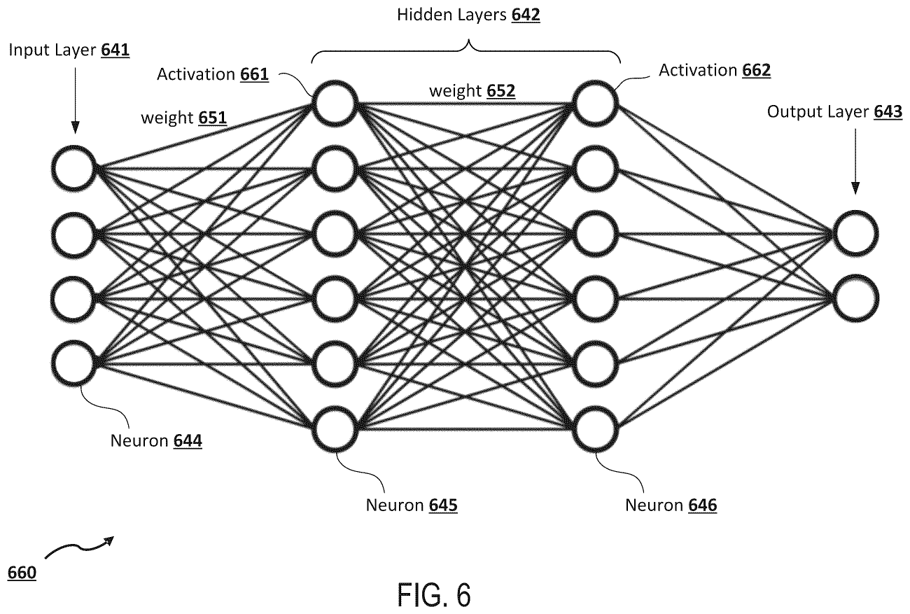

FIG. 6 is a simplified diagram illustrating the neural network structure, according to some embodiments. In some embodiments, the image processing module 530 may be implemented at least partially via an artificial neural network structure shown in FIG. 6. The neural network comprises a computing system that is built on a collection of connected units or nodes, referred to as neurons (e.g., 644, 645, 646). Neurons are often connected by edges, and an adjustable weight (e.g., 651, 652) is often associated with the edge. The neurons are often aggregated into layers such that different layers may perform different transformations on the respective input and output transformed input data onto the next layer.

For example, the neural network architecture may comprise an input layer 641, one or more hidden layers 642 and an output layer 643. Each layer may comprise a plurality of neurons, and neurons between layers are interconnected according to a specific topology of the neural network topology. The input layer 641 receives the input data such as training data, user input data, vectors representing latent features, etc. The number of nodes (neurons) in the input layer 641 may be determined by the dimensionality of the input data (e.g., the length of a vector of the input). Each node in the input layer represents a feature or attribute of the input.

The hidden layers 642 are intermediate layers between the input and output layers of a neural network. It is noted that two hidden layers 642 are shown in FIG. 6 for illustrative purpose only, and any number of hidden layers may be utilized in a neural network structure. Hidden layers 642 may extract and transform the input data through a series of weighted computations and activation functions.

For example, as discussed in FIG. 5, the image processing module 530 receives an input 540 and transforms the input into an output 550. To perform the transformation, a neural network such as the one illustrated in FIG. 6 may be utilized to perform, at least in part, the transformation. Each neuron receives input signals, performs a weighted sum of the inputs according to weights assigned to each connection (e.g., 651, 652), and then applies an activation function (e.g., 661, 662, etc.) associated with the respective neuron to the result. The output of the activation function is passed to the next layer of neurons or serves as the final output of the network. The activation function may be the same or different across different layers. Example activation functions include but not limited to Sigmoid, hyperbolic tangent, Rectified Linear Unit (ReLU), Leaky ReLU, Softmax, and/or the like. In this way, after a number of hidden layers, input data received at the input layer 641 is transformed into rather different values indicative data characteristics corresponding to a task that the neural network structure has been designed to perform.

The output layer 643 is the final layer of the neural network structure. It produces the network's output or prediction based on the computations performed in the preceding layers (e.g., 641, 642). The number of nodes in the output layer depends on the nature of the task being addressed. For example, in a binary classification problem, the output layer may consist of a single node representing the probability of belonging to one class. In a multi-class classification problem, the output layer may have multiple nodes, each representing the probability of belonging to a specific class.

Therefore, the image processing module 530 may comprise the transformative neural network structure of layers of neurons, and weights and activation functions describing the non-linear transformation at each neuron. Such a neural network structure is often implemented on one or more hardware processors 510, such as a graphics processing unit (GPU).

In one embodiment, the image processing module 530 may be implemented by hardware, software and/or a combination thereof. For example, the image processing module 530 may comprise a specific neural network structure implemented and run on various hardware platforms 660, such as but not limited to CPUs (central processing units), GPUs (graphics processing units), FPGAs (field-programmable gate arrays), Application-Specific Integrated Circuits (ASICs), dedicated AI accelerators like TPUs (tensor processing units), and specialized hardware accelerators designed specifically for the neural network computations described herein, and/or the like. Example specific hardware for neural network structures may include, but not limited to Google Edge TPU, Deep Learning Accelerator (DLA), NVIDIA AI-focused GPUs, and/or the like. The hardware 660 used to implement the neural network structure is specifically configured based on factors such as the complexity of the neural network, the scale of the tasks (e.g., training time, input data scale, size of training dataset, etc.), and the desired performance.

In one embodiment, the neural network based image processing module 530 may be trained by iteratively updating the underlying parameters (e.g., weights 651, 652, etc., bias parameters and/or coefficients in the activation functions 661, 662 associated with neurons) of the neural network based on a loss function. For example, during forward propagation, the training data such as known-good pairs of latent vectors (e.g., latent representation 104) with corresponding images (e.g., image 108) and/or latent 3D representations, etc. are fed into the neural network. The data flows through the network's layers 641, 642, with each layer performing computations based on its weights, biases, and activation functions until the output layer 643 produces the network's output 650. In some embodiments, output layer 643 produces an intermediate output on which the network's output 650 is based.

The output generated by the output layer 643 is compared to the expected output (e.g., a “ground-truth” such as the corresponding ground truth latent representation or image) from the training data, to compute a loss function that measures the discrepancy between the predicted output and the expected output. Given a loss function, the negative gradient of the loss function is computed with respect to each weight of each layer individually. Such negative gradient is computed one layer at a time, iteratively backward from the last layer 643 to the input layer 641 of the neural network. These gradients quantify the sensitivity of the network's output to changes in the parameters. The chain rule of calculus is applied to efficiently calculate these gradients by propagating the gradients backward from the output layer 643 to the input layer 641.

Parameters of the neural network are updated backwardly from the last layer to the input layer (backpropagating) based on the computed negative gradient using an optimization algorithm to minimize the loss. The backpropagation from the last layer 643 to the input layer 641 may be conducted for a number of training samples in a number of iterative training epochs. In this way, parameters of the neural network may be gradually updated in a direction to result in a lesser or minimized loss, indicating the neural network has been trained to generate a predicted output value closer to the target output value with improved prediction accuracy. Training may continue until a stopping criterion is met, such as reaching a maximum number of epochs or achieving satisfactory performance on the validation data. At this point, the trained network can be used to make predictions on new, unseen data, such as new images.

Neural network parameters may be trained over multiple stages. For example, initial training (e.g., pre-training) may be performed on one set of training data, and then an additional training stage (e.g., fine-tuning) may be performed using a different set of training data. In some embodiments, all or a portion of parameters of one or more neural-network model being used together may be frozen, such that the “frozen” parameters are not updated during that training phase. This may allow, for example, a smaller subset of the parameters to be trained without the computing cost of updating all of the parameters.

The neural network illustrated in FIG. 6 is exemplary. For example, different neural network structures may be utilized, and additional neural-network based or non-neural-network based component may be used in conjunction as part of module 530. For example, a text input may first be embedded by an embedding model, a self-attention layer, etc. into a feature vector. The feature vector may be used as the input to input layer 641. Output from output layer 643 may be output directly to a user or may undergo further processing. For example, the output from output layer 643 may be decoded by a neural network based decoder. The neural network illustrated in FIG. 600 and described herein is representative and demonstrates a physical implementation for performing the methods described herein.

Through the training process, the neural network is “updated” into a trained neural network with updated parameters such as weights and biases. The trained neural network may be used in inference to perform the tasks described herein, for example those performed by module 530. The trained neural network thus improves neural network technology in image processing and 3D generation.

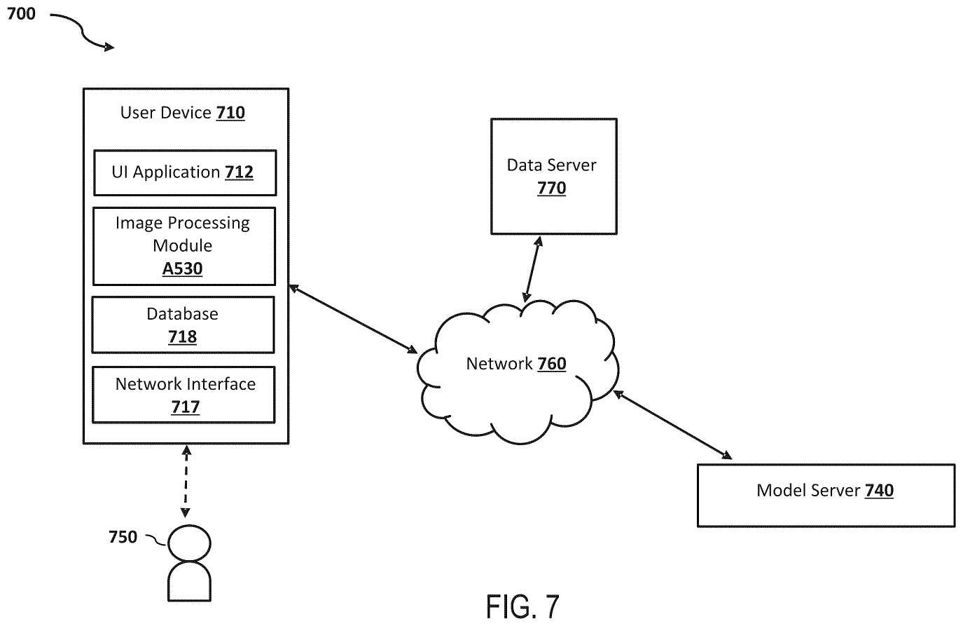

FIG. 7 is a simplified block diagram of a networked system 700 suitable for implementing the framework described herein. In one embodiment, system 700 includes the user device 710 (e.g., computing device 500) which may be operated by user 750, data server 770, model server 740, and other forms of devices, servers, and/or software components that operate to perform various methodologies in accordance with the described embodiments. Exemplary devices and servers may include device, stand-alone, and enterprise-class servers which may be similar to the computing device 500 described in FIG. 5, operating an OS such as a MICROSOFT® OS, a UNIX® OS, a LINUX® OS, a real-time operation system (RTOS), or other suitable device and/or server-based OS. It can be appreciated that the devices and/or servers illustrated in FIG. 7 may be deployed in other ways and that the operations performed, and/or the services provided by such devices and/or servers may be combined or separated for a given embodiment and may be performed by a greater number or fewer number of devices and/or servers. One or more devices and/or servers may be operated and/or maintained by the same or different entities. In some embodiments, user device 710 is used in training neural network based models. In some embodiments, user device 710 is used in performing inference tasks using pre-trained neural network based models (locally or on a model server such as model server 740).

User device 710, data server 770, and model server 740 may each include one or more processors, memories, and other appropriate components for executing instructions such as program code and/or data stored on one or more computer readable mediums to implement the various applications, data, and steps described herein. For example, such instructions may be stored in one or more computer readable media such as memories or data storage devices internal and/or external to various components of system 700, and/or accessible over network 760. User device 710, data server 770, and/or model server 740 may be a computing device 500 (or similar) as described herein.

In some embodiments, all or a subset of the actions described herein may be performed solely by user device 710. In some embodiments, all or a subset of the actions described herein may be performed in a distributed fashion by various network devices, for example as described herein.

User device 710 may be implemented as a communication device that may utilize appropriate hardware and software configured for wired and/or wireless communication with data server 770 and/or the model server 740. For example, in one embodiment, user device 710 may be implemented as an autonomous driving vehicle, a personal computer (PC), a smart phone, laptop/tablet computer, wristwatch with appropriate computer hardware resources, eyeglasses with appropriate computer hardware (e.g., GOOGLE GLASS®), other type of wearable computing device, implantable communication devices, and/or other types of computing devices capable of transmitting and/or receiving data, such as an IPAD® from APPLE®. Although only one communication device is shown, a plurality of communication devices may function similarly.

User device 710 of FIG. 7 contains a user interface (UI) application 712, and image processing module 530, which may correspond to executable processes, procedures, and/or applications with associated hardware. For example, the user device 710 may allow a user to generate UV maps and/or 3D meshes from a single image, edit images, etc. In other embodiments, user device 710 may include additional or different modules having specialized hardware and/or software as required.

In various embodiments, user device 710 includes other applications as may be desired in particular embodiments to provide features to user device 710. For example, other applications may include security applications for implementing client-side security features, programmatic client applications for interfacing with appropriate application programming interfaces (APIs) over network 760, or other types of applications. Other applications may also include communication applications, such as email, texting, voice, social networking, and IM applications that allow a user to send and receive emails, calls, texts, and other notifications through network 760.

Network 760 may be a network which is internal to an organization, such that information may be contained within secure boundaries. In some embodiments, network 760 may be a wide area network such as the internet. In some embodiments, network 760 may be comprised of direct physical connections between the devices. In some embodiments, network 760 may represent communication between different portions of a single device (e.g., a communication bus on a motherboard of a computation device).

Network 760 may be implemented as a single network or a combination of multiple networks. For example, in various embodiments, network 760 may include the Internet or one or more intranets, landline networks, wireless networks, and/or other appropriate types of networks. Thus, network 760 may correspond to small scale communication networks, such as a private or local area network, or a larger scale network, such as a wide area network or the Internet, accessible by the various components of system 700.

User device 710 may further include database 718 stored in a transitory and/or non-transitory memory of user device 710, which may store various applications and data (e.g., model parameters) and be utilized during execution of various modules of user device 710. Database 718 may store parameters, latent vector representations, images, UV maps, 3D meshes, etc. In some embodiments, database 718 may be local to user device 710. However, in other embodiments, database 718 may be external to user device 710 and accessible by user device 710, including cloud storage systems and/or databases that are accessible over network 760 (e.g., on data server 770).

User device 710 may include at least one network interface component 717 adapted to communicate with data server 770 and/or model server 740. In various embodiments, network interface component 717 may include a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency, infrared, Bluetooth, and near field communication devices.

Data Server 770 may perform some of the functions described herein. For example, data server 770 may store a training dataset including known-good pairs of latent vectors (e.g., latent representation 104) with corresponding images (e.g., image 108) and/or latent 3D representations, etc. Data server 770 may provide data to user device 710 and/or model server 740. For example, training data may be stored on data server 770 and that training data may be retrieved by model server 740 while training a model stored on model server 740.

Model server 740 may be a server that hosts models described herein. Model server 740 may provide an interface via network 760 such that user device 710 may perform functions relating to the models as described herein (e.g., image to UV map generation). Model server 740 may communicate outputs of the models to user device 710 via network 760. User device 710 may display model outputs, or information based on model outputs, via a user interface to user 750.

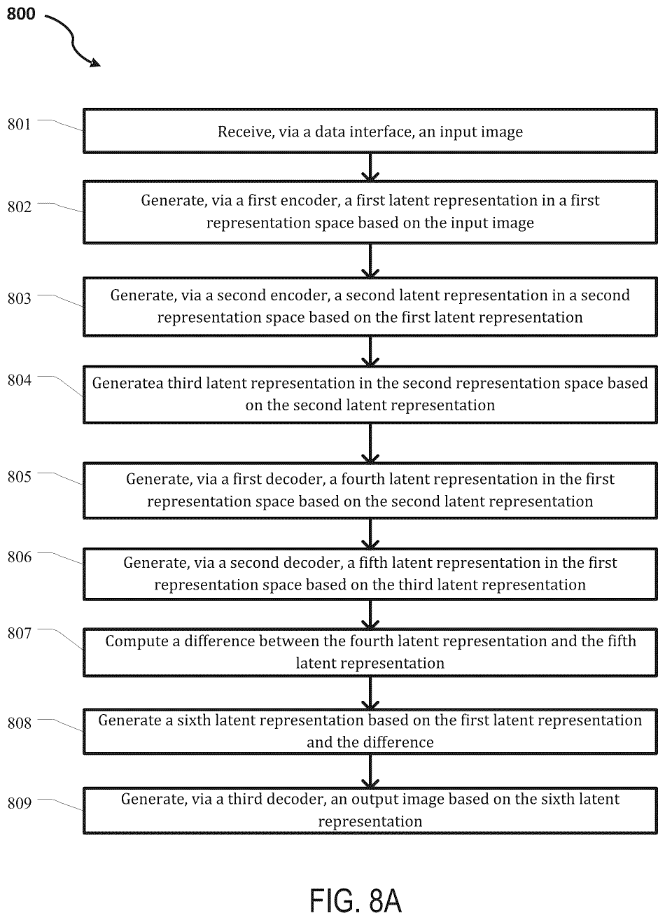

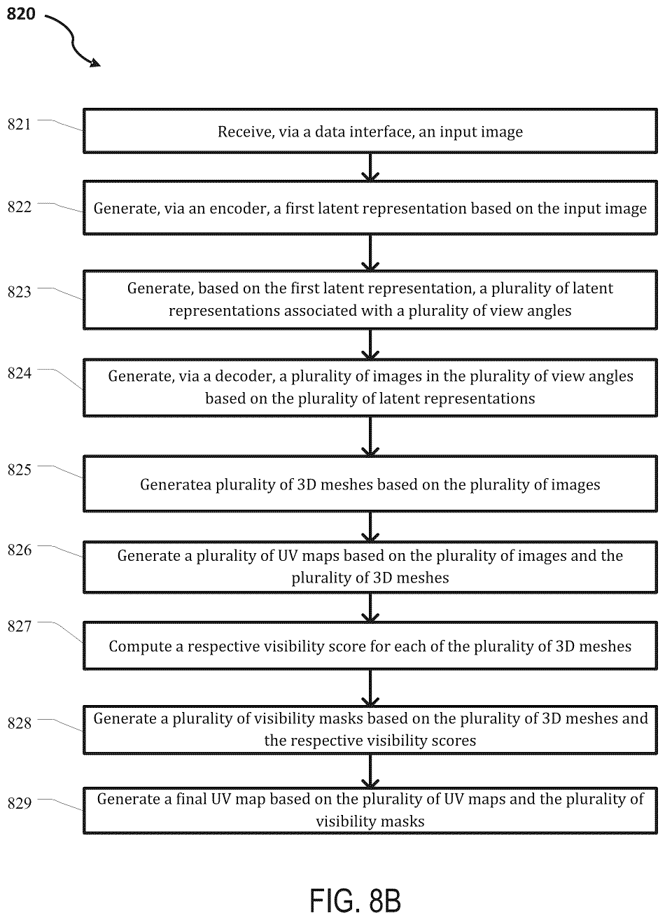

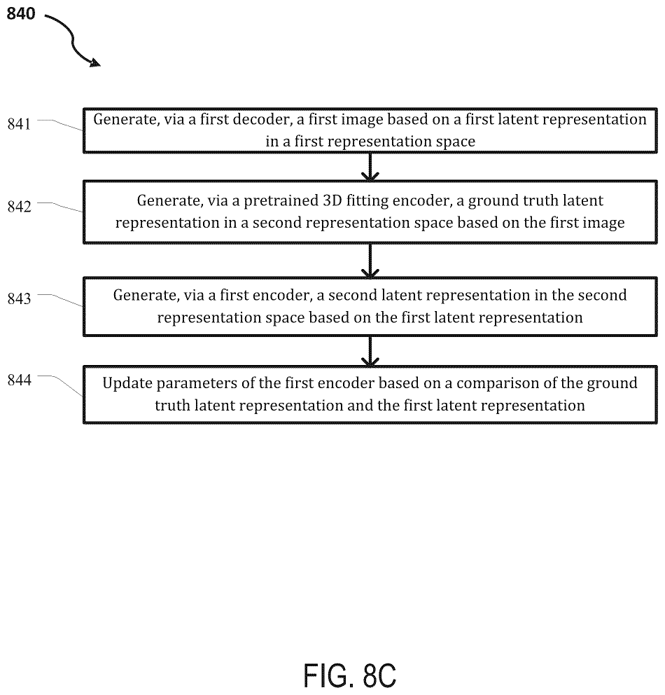

FIGS. 8A-8C are example logic flow diagrams, according to some embodiments. While described separately, elements of each of the methods in FIGS. 8A-8C may, in some embodiments, be performed together. For example, the training method in FIG. 8C may be used to train a model utilized in the method described in FIG. 8A or FIG. 8B. In another example, the method of generating an image as described in FIG. 8A may be utilized (in full or in part) in the UV map generation process described in FIG. 8B.

FIG. 8A is an example logic flow diagram of a method 800 for image editing, according to some embodiments described herein. One or more of the processes of method 800 may be implemented, at least in part, in the form of executable code stored on non-transitory, tangible, machine-readable media that when run by one or more processors may cause the one or more processors to perform one or more of the processes (e.g., computing device 500). In some embodiments, method 800 corresponds to the operation of the image processing module 530 or more specifically map and edit submodule 531 that performs inference of the map and edit model 110.

As illustrated, the method 800 includes a number of enumerated steps, but aspects of the method 800 may include additional steps before, after, and in between the enumerated steps. In some aspects, one or more of the enumerated steps may be omitted or performed in a different order.

At step 801, a system (e.g., computing device 500, user device 710, model server 740, device 900, or device 915) receives, via a data interface (e.g., data interface 515, network interface 717, or an interface to a sensor such as a camera), an input image (e.g., image 202 or 302).

At step 802, the system generates, via a first encoder (e.g., GAN inversion model 204), a first latent representation (e.g., latent representation w 206 or 304) in a first representation space (e.g., W+ space 216) based on the input image.

At step 803, the system generates, via a second encoder (e.g., forward mapping network 112), a second latent representation (e.g., latent representation P_{w} 126) in a second representation space (e.g., morphable space 218) based on the first latent representation.

At step 804, the system generates a third latent representation (e.g., latent representation P_{edit} 128) in the second representation space based on the second latent representation. In some embodiments, generating the third latent representation includes modifying at least one parameter associated with the second latent representation. In some embodiments, the at least one parameter includes a view angle.

At step 805, the system generates, via a first decoder (e.g., inverse mapping network 114), a fourth latent representation (e.g., latent representation ŵ 122) in the first representation space based on the second latent representation.

At step 806, the system generates, via a second decoder (e.g., inverse mapping network 114), a fifth latent representation (e.g., latent representation ŵ_{edit} 124) in the first representation space based on the third latent representation. In some embodiments, the second decoder is the same as the first decoder.

At step 807, the system computes a difference (e.g., extract dₐₜₜ 212) between the fourth latent representation and the fifth latent representation.

At step 808, the system generates a sixth latent representation based on the first latent representation and the difference.

At step 809, the system generates, via a third decoder (e.g., decoder 106, realistic generator 310, or style transfer generator 308), an output image (e.g., image 214 or one of images 312) based on the sixth latent representation. In some embodiments, the system receives (e.g., via the data interface) a second input image. This second input image may be used to control the style of the output image. In some embodiments, the system may input the second image to the third decoder (e.g., style transfer generator 308) as a conditioning input. Thereby, the style of the second input image (e.g., cartoon, sketch, etc.) may be transferred to the output image.

FIG. 8B is an example logic flow diagram of a method 820 for image to UV map generation, according to some embodiments described herein. One or more of the processes of method 820 may be implemented, at least in part, in the form of executable code stored on non-transitory, tangible, machine-readable media that when run by one or more processors may cause the one or more processors to perform one or more of the processes (e.g., computing device 500). In some embodiments, method 820 corresponds to the operation of the image processing module 530, or more specifically to UV map generation submodule 532 that performs image to UV map generation inference.

As illustrated, the method 820 includes a number of enumerated steps, but aspects of the method 820 may include additional steps before, after, and in between the enumerated steps. In some aspects, one or more of the enumerated steps may be omitted or performed in a different order.

At step 821, a system (e.g., computing device 500, user device 710, model server 740, device 900, or device 915) receives, via a data interface (e.g., data interface 515, network interface 717, or an interface to a sensor such as a camera), an input image (e.g., image 202 or 302).

At step 822, the system generates, via an encoder (e.g., GAN inversion model 204), a first latent representation (e.g., latent representation w 206 or 304) based on the input image.

At step 823, the system generates, based on the first latent representation, a plurality of latent representations (e.g., latent representations wᵢ 306) associated with a plurality of view angles. The view angles may be predetermined/fixed view angles. The selection of view angles may be determined for optimal UV map generation. In some embodiments, the plurality of latent representations may be generated using a map and edit model 110. For example, the first latent representation may be in a first representation space (e.g., W+ space 216). The system may generate, via a second encoder (e.g., forward mapping network 112), a second latent representation (e.g., latent representation P_{w} 126) in a second representation space (e.g., morphable space 218) based on the first latent representation. The system may generate a first plurality of edited latent representations (e.g., multiple variations of latent representation P_{edit} 128 corresponding to different view angles) in the second representation space based on the second latent representation. The system may generate, via a second decoder (e.g., inverse mapping network 114), a second plurality of edited latent representations (e.g., multiple variations of latent representation ŵ_{edit} 124) in the first representation space based on the first plurality of edited latent representations. The system may generate, via a third decoder (e.g., inverse mapping network 114), a third latent representation (e.g., latent representation ŵ 122) in the first representation space based on the second latent representation. The system may compute a plurality of vector directions based on a comparison of the third latent representation and the second plurality of edited latent representations (e.g., each vector direction may be determined by finding the difference between the third latent representation and each of the second plurality of edited latent representations). The system may generate the plurality of latent representations based on the first latent representation and the plurality of vector directions.

At step 824, the system generates, via a decoder (e.g., realistic generator 310, or style transfer generator 308), a plurality of images (e.g., images 312) in the plurality of view angles based on the plurality of latent representations. In some embodiments, the system receives (e.g., via the data interface) a second input image. This second input image may be used to control the style of the plurality of images. In some embodiments, the system may input the second image to the decoder (e.g., style transfer generator 308) as a conditioning input. Thereby, the style of the second input image (e.g., cartoon, sketch, etc.) may be transferred to the plurality of images.

At step 825, the system generates a plurality of 3D meshes (e.g., vertices Sᵢ 314) based on the plurality of images.

At step 826, the system generates, a plurality of UV maps (e.g., UV maps 318) based on the plurality of images and the plurality of 3D meshes.

At step 827, the system computes a respective visibility score (e.g., visibility scores Vᵢ) for each of the plurality of 3D meshes.

At step 828, the system generates a plurality of visibility masks (e.g., visibility masks M 320) based on the plurality of 3D meshes and the respective visibility scores.

At step 829, the system generates a final UV map (e.g., UV map 322) based on the plurality of UV maps and the plurality of visibility masks. In some embodiments, generating the final UV map includes multiplying each visibility mask of the plurality of visibility masks with a corresponding UV map of the plurality of UV maps. In some embodiments, the plurality of UV maps and the plurality of visibility masks are combined according to equation (11). In some embodiments, the system generates a 3D model by applying the final UV map to a 3D mesh.

FIG. 8C is an example logic flow diagram of a method 840 for training a neural network based model (e.g., forward mapping network 112 and/or inverse mapping network 114), according to some embodiments described herein. One or more of the processes of method 840 may be implemented, at least in part, in the form of executable code stored on non-transitory, tangible, machine-readable media that when run by one or more processors may cause the one or more processors to perform one or more of the processes (e.g., computing device 500). In some embodiments, method 840 corresponds to the operation of the image processing module 530 or more specifically map and edit submodule 531 that performs training of the map and edit model 110.

As illustrated, the method 840 includes a number of enumerated steps, but aspects of the method 840 may include additional steps before, after, and in between the enumerated steps. In some aspects, one or more of the enumerated steps may be omitted or performed in a different order.

At step 841, a system (e.g., computing device 500, user device 710, model server 740, device 900, or device 915) generates, via a first decoder (e.g., pretrained decoder 106), a first image (e.g., image 108) based on a first latent representation (e.g., latent representation w 104) in a first representation space (e.g., W+ space 216). In some embodiments, the first latent representation is initialized by the system with a random noise value (e.g., noise 102).

At step 842, the system generates, via a pretrained 3D fitting encoder (e.g., pretrained 3D fitting encoder 116), a ground truth latent representation (e.g., representation 132 \hat{P}_{w}) in a second representation space (e.g., morphable space 218) based on the first image.

At step 843, the system generates, via a first encoder (e.g., forward mapping network 112), a second latent representation (e.g., latent representation P_{w} 126) in the second representation space based on the first latent representation.

At step 844, the system updates parameters of the first encoder based on a comparison of the ground truth latent representation and the first latent representation (e.g., 3DMM parameter loss as described in equation (4)). Alternative loss functions may be used instead of or in addition to the 3DMM parameter loss as described herein.

In some embodiments, the system may also extract a first plurality of 3D landmarks (e.g., q_{w}) from the ground truth latent representation, and extract a second plurality of 3D landmarks (e.g., q_{w}) from the second latent representation. Updating parameters of the first encoder may be further based on a comparison of the first plurality of 3D landmarks and the second plurality of 3D landmarks (e.g., the first term of the landmark loss as described in equation (6)).

In some embodiments, the system may generate a third latent representation (e.g., latent representation 128 P_{edit}) in the second representation space based on the second latent representation. The system may then generate, via a second decoder (e.g., inverse mapping network 114), a fourth latent representation (e.g., latent representation 124 W edit) in the first representation space based on the third latent representation. The system may then generate, via the first encoder, a fifth latent representation (e.g., P_{edit}) in the second representation space based on the fourth latent representation. (e.g., the second term of the landmark loss as described in equation (6)). The system may extract a first plurality of 3D landmarks (e.g., q_{edit}) from the third latent representation, and extract a second plurality of 3D landmarks (e.g., \hat{q}_{edit}) from the fifth latent representation. Updating parameters of the first encoder may be further based on a comparison of the first plurality of 3D landmarks and the second plurality of 3D landmarks (e.g., the second term of the landmark loss as described in equation (6)).

In some embodiments, the system may generate, via a second decoder (e.g., renderer 130), a first rendered image (e.g., image 118) based on the ground truth latent representation. The system may further generate, via a third decoder (e.g., renderer 130), a second rendered image (e.g., image 120) based on the second latent representation. Updating parameters of the first encoder may be further based on a comparison of the first rendered image and the second rendered image (e.g., rendered image loss as described in equation (5)).

In some embodiments, the system may generate, via a second decoder (e.g., inverse mapping network 114), a fourth latent representation (e.g., latent representation ŵ 122) in the first representation space based on the second latent representation. Updating parameters of the first encoder may be further based on a comparison of the first latent representation and the fourth latent representation (e.g., reconstruction loss as described in equation (5)). In some embodiments, the system updates parameters of the second decoder based on the comparison of the first latent representation and the fourth latent representation.

In some embodiments, the system may update parameters of the first encoder further based on one or more parameters associated with the second latent representation (e.g., regularization loss as described in equation (7)). The one or more parameters may include at least one of an identity parameter, an expression parameter, or a texture parameter of latent representation 126 P_{w}.

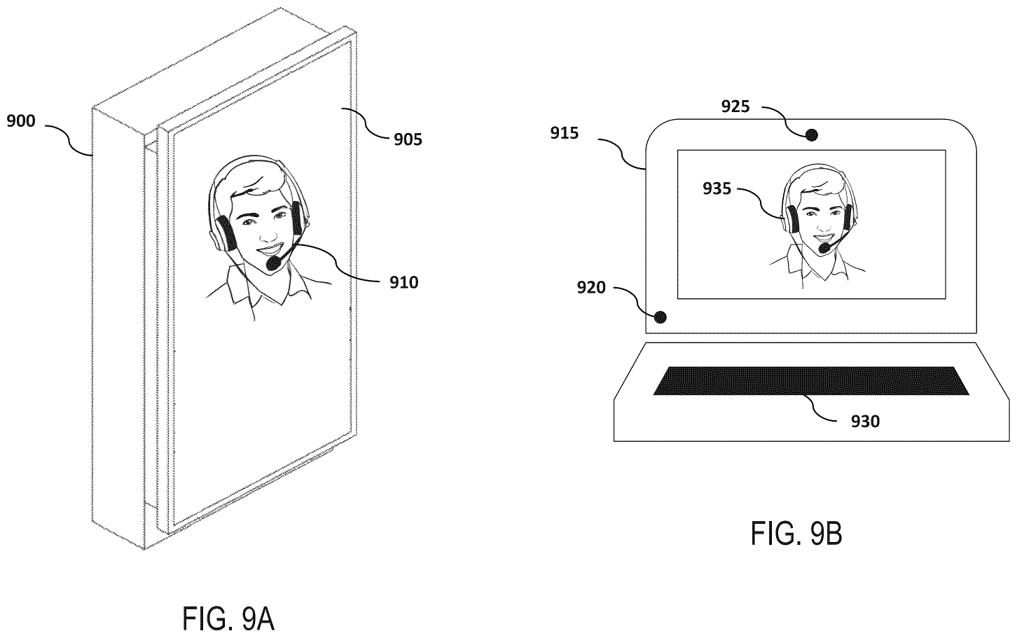

FIG. 9A is an exemplary device 900 with a digital avatar interface, according to some embodiments. Device 900 may be, for example, a kiosk that is available for use at a store, a library, a transit station, etc. Device 900 may display a digital avatar 910 on display 905. In some embodiments, a user may interact with the digital avatar 910 as they would a person, using voice and non-verbal gestures. Digital avatar 910 may interact with a user via digitally synthesized gestures, digitally synthesized voice, etc. In some embodiments, the visual depiction of digital avatar 910 may be rendered based on a 3D model that is created with a 3D mesh and/or UV map generated as described herein. For example, a reference portrait may be provided, and using the methods described herein, a UV map may be generated (in a selected style) to map to a 3D mesh for digital avatar 910. The 3D mesh may be manipulated according to an automatically generated gesture.

Device 900 may include one or more microphones, and one or more image-capture devices (not shown) for user interaction. Device 900 may be connected to a network (e.g., network 760). Digital Avatar 910 may be controlled via local software and/or through software that is at a central server accessed via a network. For example, an AI model may be used to control the behavior of digital avatar 910, and that AI model may be run remotely. In some embodiments, device 900 may be configured to perform functions described herein (e.g., via digital avatar 910). For example, device 900 may perform one or more of the functions as described with reference to computing device 500 or user device 710. For example, UV map generation.

FIG. 9B is an exemplary device 915 with a digital avatar interface, according to some embodiments. Device 915 may be, for example, a personal laptop computer or other computing device. Device 915 may have an application that displays a digital avatar 935 with functionality similar to device 900. For example, device 915 may include a microphone 920 and image capturing device 925, which may be used to interact with digital avatar 935. In addition, device 915 may have other input devices such as a keyboard 930 for entering text.

Digital avatar 935 may interact with a user via digitally synthesized gestures, digitally synthesized voice, etc. In some embodiments, the visual depiction of digital avatar 935 may be rendered based on a 3D model that is created with a 3D mesh and/or UV map generated as described herein. For example, a reference portrait may be provided, and using the methods described herein, a UV map may be generated (in a selected style) to map to a 3D mesh for digital avatar 935. The 3D mesh may be manipulated according to an automatically generated gesture. In some embodiments, device 915 may be configured to perform functions described herein (e.g., via digital avatar 935). For example, device 915 may perform one or more of the functions as described with reference to computing device 500 or user device 710. For example, UV map generation.

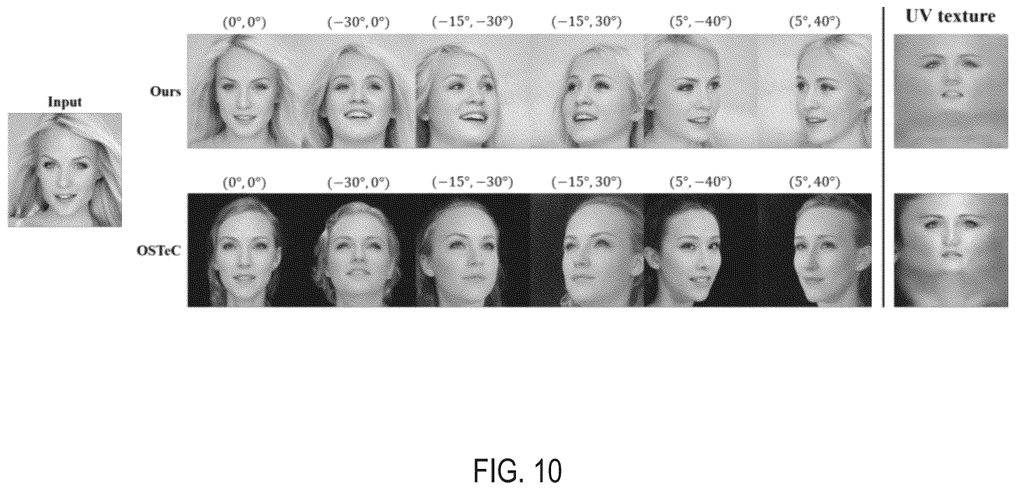

FIGS. 10-18 provide charts and images illustrating exemplary performance of different embodiments described herein. Baseline models utilized in the experiments include OSTeC as described in Gecer et al., Ostec: One-shot texture completion, CVPR, pp. 7628-7638, 2021; LiftedGAN as described in Shi et al., Lifting 2D StyleGAN for 3D-Aware Face Generation, CVPR, 2021; DiscoFaceGAN as described in Deng et al., Disentangled and controllable face image generation via 3d imitative-contrastive learning, IEEE Computer Vision and Pattern Recognition, 2020; a method described in Kwak et al, Injecting 3d perception of controllable nerf-gan into stylegan for editable portrait image synthesis, arXiv: 2207.10257, 2022; and ConfigNET as described in Kowalski et al., CONFIG: Controllable Neural Face Image Generation, arXiv: 2005.02671, 2020.

Metrics used in FIGS. 10-18 include FID as described in Heusel et al., GANs trained by a two time-scale update rule converge to a local nash equilibrium, NeurIPS 30, 2017; pose accuracy estimated by a 3D model as described in Guo et al., Towards fast, accurate and stable 3D dense face alignment, ECCV, 2020; and identity similarity as described in Deng et al., Arcface: Additive angular margin loss for deep face recognition, CVPR, pp. 4690-4699, 2019. Embodiments of the methods described herein are indicated in the charts as “Ours”.

FIG. 10 illustrates comparison results of the method described herein and OSTeC's face rotation. The right column is the UV maps synthesized by the corresponding methods. Many 3D texture completion methods often rely on large-scale high-quality 3D appearance data, which is expensive and difficult to collect. OSTeC needs to be optimized for each input image, which requires a long inference time. Moreover, the results of each optimization are not very stable in terms of identity consistency. The method described herein is based on a model with better generalization and, thus, better performance in terms of stability. It can be seen from FIG. 10 that the identity of the multi-view face images generated by OSTeC is quite different from that of the input image, and the identity consistency of each angle of the face is relatively low. In contrast, the face images generated by the method described herein maintains better identities.

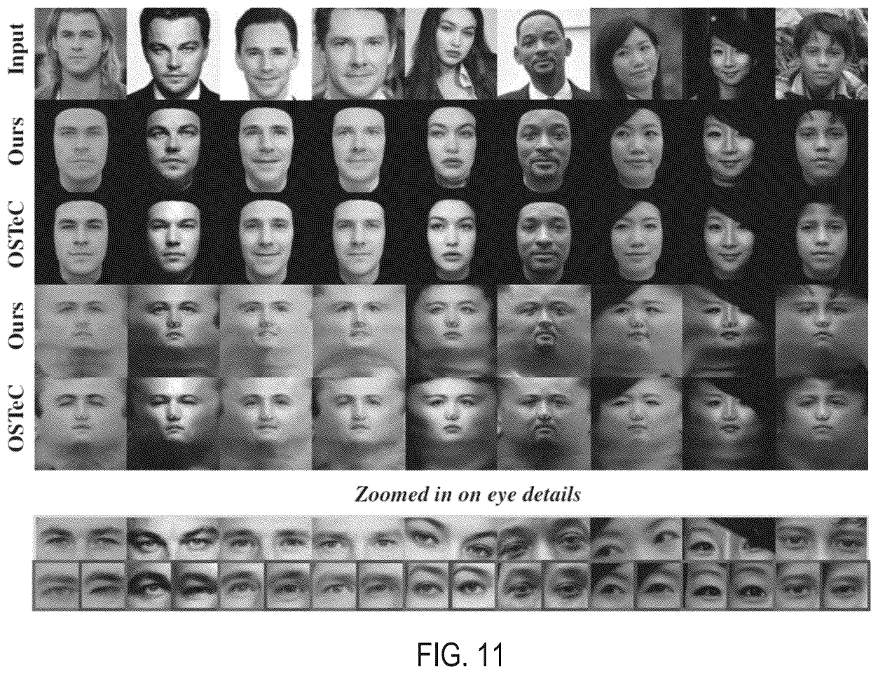

FIG. 11 illustrates Comparison results of UV map and 3D mesh of out of domain image. For the Zoomed in on eye details, the image with both eyes is the enlarged part of the input image, and the image on the left of each pair of single-eye images are generated by a model using the methods described herein, and the image on the right is generated by OSTeC. The method described herein has significantly better performance on the facial details of the generated UV map, such as identity consistency, beard and wrinkles. Especially, in the details of the eye part, results show superior performance compared with OSTeC.

The method described herein is also able to synthesize the UV map from domain images. This approach facilitates the editing of real images. Since the input image is not within the StyleGAN training data range, the generated results of OSTeC and input image will have some identity differences. The method described herein can be plugged into the HyperStyle method without any fine-tuning process. HyperStyle may be as described in Alaluf et al., Hyperstyle: StyleGAN inversion with hypernetworks for real image editing, 2021. Hyper style is based on an encoder with good generalization and also performs tuning on the generator, so it has a better advantage in editing out-of-domain images. FIG. 11 shows the results of the UV map, 3D reconstruction results, and zoomed-in image of eye detail. As illustrated, the method described herein (“ours”) has a better identity-preserving ability on some face and eye details.

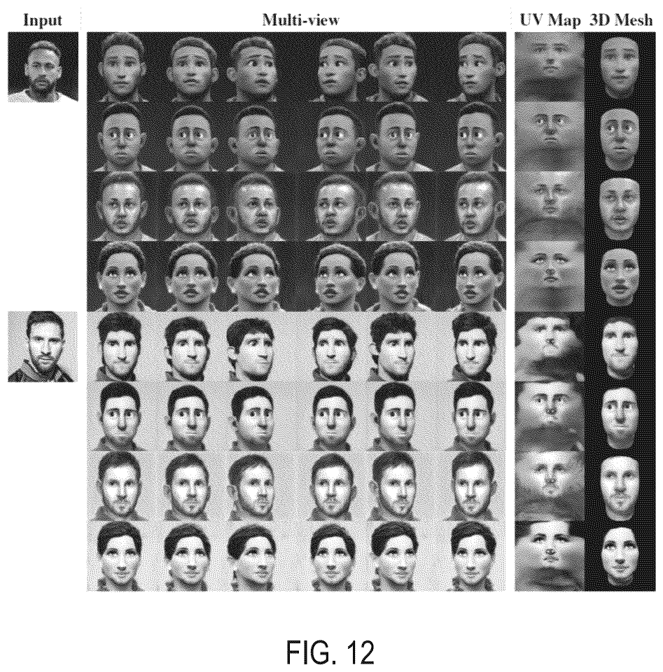

FIG. 12 illustrates qualitative results of UV map and 3D mesh in different styles. In this study, four different styles of StyleGAN2 were obtained through fine-tuning. As can be seen in FIG. 12, four different styles of images were generated, from top to bottom toonify, pixar, sketch, and Disney styles. Since the similar domain StyleGAN2 has the semantic alignment characteristic, the semantics of the fine-tuning StyleGAN2 can be controlled by controlling the semantics of the original StyleGAN2. As shown in the results of multi-view images, the W+ latent space of different fine-tuning models can also be edited by methods described herein. As shown in the results of the UV map and 3D mesh, the method described herein successfully achieves high-quality UV map generation in different styles. Due to the limitation of the training set used in transfer learning, some styles will cause the identity information of some characters to disappear, for example, the disappearance of beards and turning into female characters.

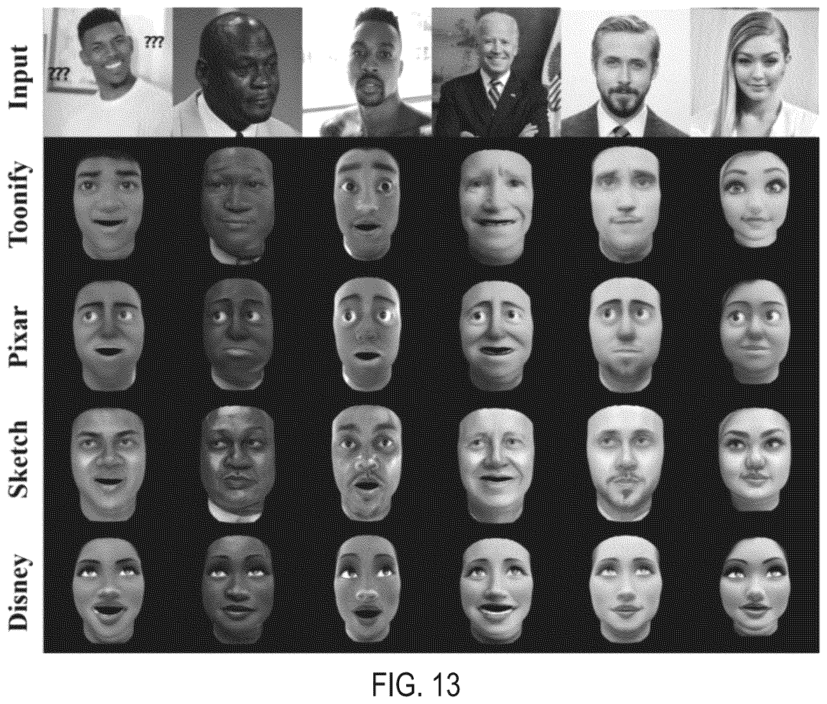

FIG. 13 illustrates More qualitative results of 3D mesh after style conversion. As shown in FIG. 13, the methods described herein can generate a high-quality 3D mesh in different styles even if the input images are out of the domain. At the same time, the synthesized 3D mesh has skin color and expression features to a certain extent, corresponding to the input image.

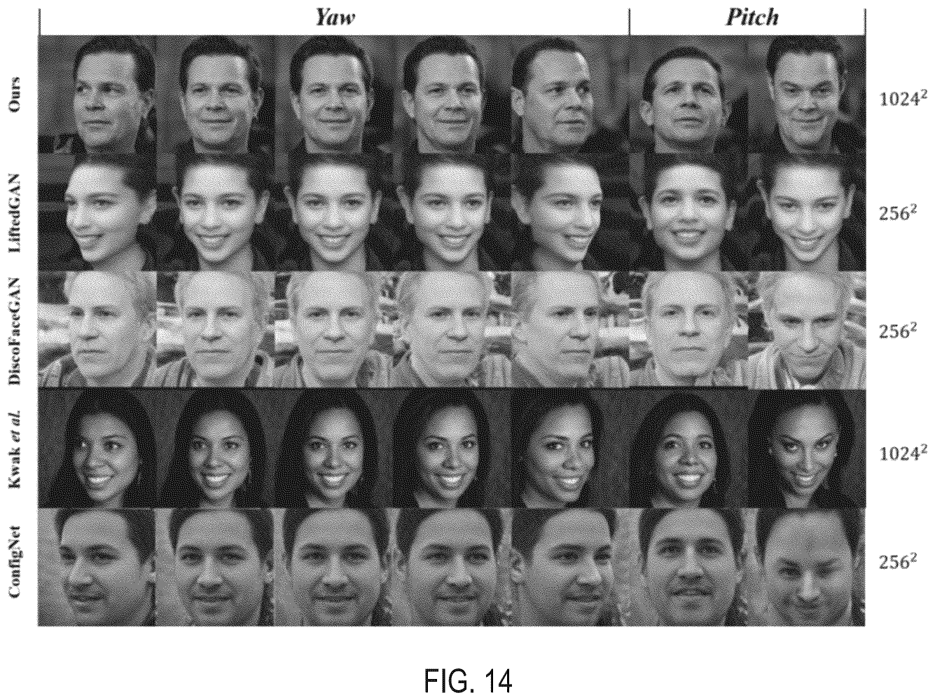

FIG. 14 illustrates qualitative comparison results of random face rotation. Explicit control over the 3D parameters allows the methods described herein to turn StyleGAN into a conditional generative model. One can simply enter the pose, expression, or lighting parameters into ‘Map and edit’ to generate an image corresponding to the specified parameters. That is, the methods described herein provide explicit control over the pretrained StyleGAN2. FIG. 14 shows the comparison results of the method described herein (“ours”), discofacegan, configNet, Kwak et al and LiftedGAN on pose variation. The results show that the method described herein is better at rotating portrait images while keeping other conditions, such as identity unchanged. The result of LiftedGAN is distorted after a large angle rotation. The result of ConfigNet is distorted in the rotation result in the pitch direction. DiscofaceGAN and Kwak et al have achieved good results in this regard. Whereas DiscofaceGAN relies on training the entire GAN, Kwak et al relies on nerf-based generators. These all require costly training resources. And DiscofaceGAN cannot explicitly control the face pose. The method described herein only needs to optimize the proposed ‘Map and edit’ network and does not require any dataset.

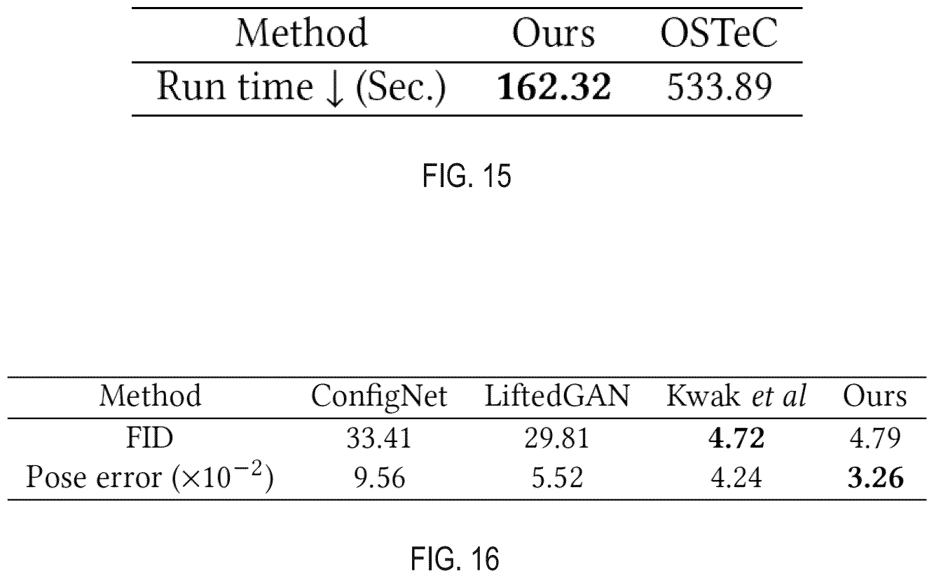

FIG. 15 illustrates a comparison of runtime from single image to UV map generation with OSTeC in the method described herein. FIG. 15 shows the average run time is about 30% of OSTeC. The main time-consuming difference is in the multi-view face generation part since the model described herein is based on a generator with better generalization, i.e., pretrained StyleGAN2. Therefore, this part of the time consumption can be almost ignored in the method described herein.

FIG. 16 illustrates a quantitative comparison on FID and pose error with random generated face. Compared to other baselines, the method described herein achieves competitive scores in pose accuracy.

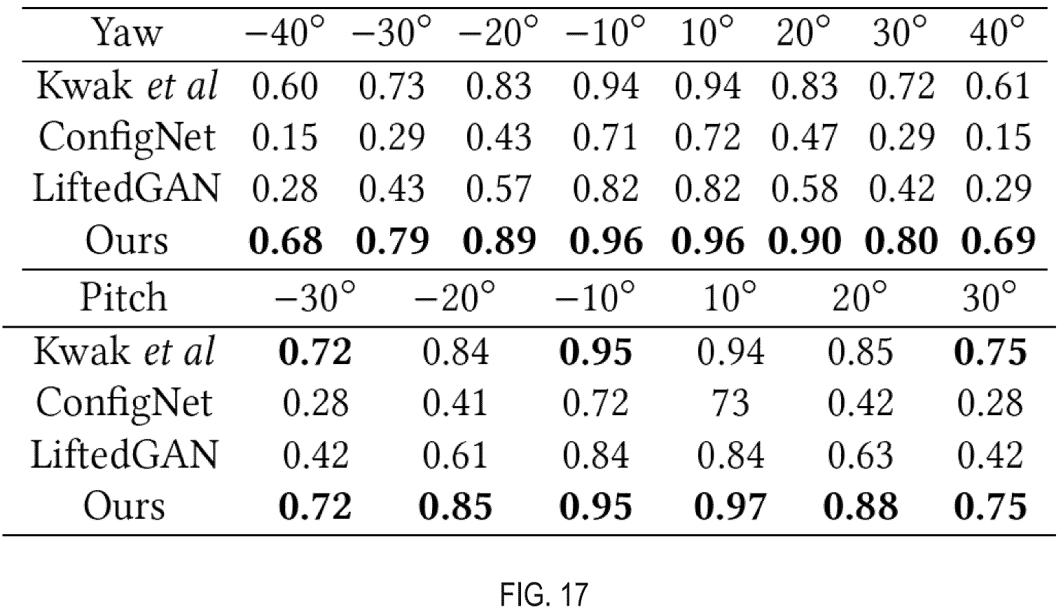

FIG. 17 illustrates cosine similarity comparison results of face rotation at specific angles with random generated face. Compared to other baselines, the method described herein achieves competitive or improved scores.

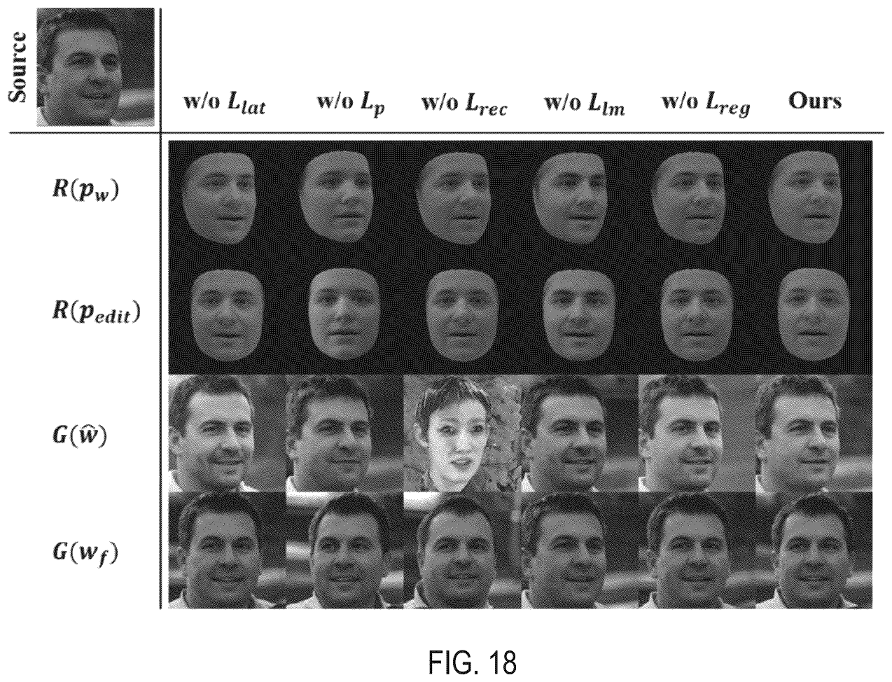

FIG. 18 illustrates the results of an ablation study. Columns from left to right are the results of removing the specified loss in turn. To verify the effectiveness of the mixed-level loss function, the model described herein was trained with different losses. Some typical results are shown in FIG. 18. The combination of rendered image loss and parameter loss can better help to map the latent code reasonably to the 3DMM space. When the rendered image loss is removed, the color and lighting of R (P_{w}) are biased. When the parameter loss is removed, the texture details of the R (P_{w}) are missing. The latent reconstruction loss helps map the 3DMM parameters p back to the W+ latent space. The landmark loss can help transform the geometry changes (pose and expression) from P_{w} to P_{edit}. The regularization loss helps the M_{f} network to speed up the convergence. The results of the last line show that the face rotation does not have much impact without the rendered image loss and regularization loss. However, a large error will occur when adjusting the lighting due to the poor feedback on the light in these two cases.

The devices described above may be implemented by one or more hardware components, software components, and/or a combination of the hardware components and the software components. For example, the device and the components described in the exemplary embodiments may be implemented, for example, using one or more general purpose computers or special purpose computers such as a processor, a controller, an arithmetic logic unit (ALU), a digital signal processor, a microcomputer, a field programmable gate array (FPGA), a programmable logic unit (PLU), a microprocessor, or any other device which executes or responds instructions. The processing device may perform an operating system (OS) and one or more software applications which are performed on the operating system. Further, the processing device may access, store, manipulate, process, and generate data in response to the execution of the software. For ease of understanding, it may be described that a single processing device is used, but those skilled in the art may understand that the processing device includes a plurality of processing elements and/or a plurality of types of the processing element. For example, the processing device may include a plurality of processors or include one processor and one controller. Further, another processing configuration such as a parallel processor may be implemented.

The software may include a computer program, a code, an instruction, or a combination of one or more of them, which configure the processing device to be operated as desired or independently or collectively command the processing device. The software and/or data may be interpreted by a processing device or embodied in any tangible machines, components, physical devices, computer storage media, or devices to provide an instruction or data to the processing device. The software may be distributed on a computer system connected through a network to be stored or executed in a distributed manner The software and data may be stored in one or more computer readable recording media.

The method according to the exemplary embodiment may be implemented as a program instruction which may be executed by various computers to be recorded in a computer readable medium. At this time, the medium may continuously store a computer executable program or temporarily store it to execute or download the program. Further, the medium may be various recording means or storage means to which a single or a plurality of hardware is coupled and the medium is not limited to a medium which is directly connected to any computer system, but may be distributed on the network. Examples of the medium may include magnetic media such as hard disk, floppy disks and magnetic tapes, optical media such as CD-ROMs and DVDs, magneto-optical media such as optical disks, and ROMs, RAMS, and flash memories to be specifically configured to store program instructions. Further, an example of another medium may include a recording medium or a storage medium which is managed by an app store which distributes application, a site and servers which supply or distribute various software, or the like.

Although the exemplary embodiments have been described above by a limited embodiment and the drawings, various modifications and changes can be made from the above description by those skilled in the art. For example, even when the above-described techniques are performed by different order from the described method and/or components such as systems, structures, devices, or circuits described above are coupled or combined in a different manner from the described method or replaced or substituted with other components or equivalents, the appropriate results can be achieved. It will be understood that many additional changes in the details, materials, steps and arrangement of parts, which have been herein described and illustrated to explain the nature of the subject matter, may be made by those skilled in the art within the principle and scope of the invention as expressed in the appended claims.

What is claimed is:

1. A method for image editing, the method comprising:
receiving, via a data interface, an input image;
generating, via a first encoder, a first latent representation in a first representation space based on the input image;
generating, via a second encoder, a second latent representation in a second representation space based on the first latent representation;
generating a third latent representation in the second representation space based on the second latent representation;
generating, via a first decoder, a fourth latent representation in the first representation space based on the second latent representation;
generating, via a second decoder, a fifth latent representation in the first representation space based on the third latent representation;
computing a difference between the fourth latent representation and the fifth latent representation;
generating a sixth latent representation based on the first latent representation and the difference; and
generating, via a third decoder, an output image based on the sixth latent representation.

2. The method of claim 1, wherein the first decoder is the same as the second decoder.

3. The method of claim 1, further comprising:
receiving, via the data interface, a second input image; and
inputting the second input image to the third decoder,
wherein the generating the output image is further based on the second input image.

4. The method of claim 1, wherein generating the third latent representation includes:
modifying at least one parameter associated with the second latent representation.

5. The method of claim 4, wherein the at least one parameter includes a view angle.

6. A method for image to UV map generation, the method comprising:
receiving, via a data interface, an input image;
generating, via an encoder, a first latent representation based on the input image;
generating, based on the first latent representation, a plurality of latent representations associated with a plurality of view angles;
generating, via a decoder, a plurality of images in the plurality of view angles based on the plurality of latent representations; and
generating a final UV map based on the plurality of images.

7. The method of claim 6, wherein the generating the final UV map includes:
generating a plurality of 3D meshes based on the plurality of images;
generating a plurality of UV maps based on the plurality of images and the plurality of 3D meshes;
computing a respective visibility score for each of the plurality of 3D meshes;
generating a plurality of visibility masks based on the plurality of 3D meshes and the respective visibility scores; and
generating the final UV map based on the plurality of UV maps and the plurality of visibility masks.

8. The method of claim 7, wherein the generating the final UV map includes multiplying each visibility mask of the plurality of visibility masks with a corresponding UV map of the plurality of UV maps.

9. The method of claim 6,
wherein the first latent representation is in a first representation space, and
wherein the generating the plurality of latent representations associated with the plurality of view angles includes:
generating, via a second encoder, a second latent representation in a second representation space based on the first latent representation;
generating a first plurality of edited latent representations in the second representation space based on the second latent representation;
generating, via a second decoder, a second plurality of edited latent representations in the first representation space based on the first plurality of edited latent representations;
generating, via a third decoder, a third latent representation in the first representation space based on the second latent representation;
computing a plurality of vector directions based on a comparison of the third latent representation and the second plurality of edited latent representations; and
generating the plurality of latent representations based on the first latent representation and the plurality of vector directions.

10. The method of claim 9, wherein the second decoder is the same as the third decoder.

11. The method of claim 6, further comprising:
receiving, via the data interface, a second input image; and
inputting the second input image to the decoder,
wherein the generating the plurality of images is further based on the second input image.

12. The method of claim 6, further comprising:
generating a 3D model by applying the final UV map to a 3D mesh.

13. A method for training a neural network based model, the method comprising:
generating, via a first decoder, a first image based on a first latent representation in a first representation space;
generating, via a pretrained 3D fitting encoder, a ground truth latent representation in a second representation space based on the first image;
generating, via a first encoder, a second latent representation in the second representation space based on the first latent representation; and
updating parameters of the first encoder based on a comparison of the ground truth latent representation and the first latent representation.

14. The method of claim 13, further comprising:
extracting a first plurality of 3D landmarks from the ground truth latent representation; and
extracting a second plurality of 3D landmarks from the second latent representation,
wherein updating parameters of the first encoder is further based on a comparison of the first plurality of 3D landmarks and the second plurality of 3D landmarks.

15. The method of claim 13, further comprising:
generating a third latent representation in the second representation space based on the second latent representation;
generating a fourth latent representation in the first representation space based on the third latent representation;
generating a fifth latent representation in the second representation space based on the fourth latent representation;
extracting a first plurality of 3D landmarks from the third latent representation; and
extracting a second plurality of 3D landmarks from the fifth latent representation,
wherein updating parameters of the first encoder is further based on a comparison of the first plurality of 3D landmarks and the second plurality of 3D landmarks.

16. The method of claim 13, further comprising:
generating, via a second decoder, a first rendered image based on the ground truth latent representation; and
generating, via a third decoder, a second rendered image based on the second latent representation,
wherein updating parameters of the first encoder is further based on a comparison of the first rendered image and the second rendered image.

17. The method of claim 13, further comprising:
generating, via a second decoder, a fourth latent representation in the first representation space based on the second latent representation,
wherein updating parameters of the first encoder is further based on a comparison of the first latent representation and the fourth latent representation.

18. The method of claim 17, further comprising:
updating parameters of the second decoder based on the comparison of the first latent representation and the fourth latent representation.

19. The method of claim 13,
wherein updating parameters of the first encoder is further based on one or more parameters associated with the second latent representation, and
wherein the one or more parameters include at least one of an identity parameter, an expression parameter, or a texture parameter.

20. The method of claim 13, further comprising:
initializing the first latent representation with a random noise value.
